(19) United States
(12) Patent Application Publication
(10) Pub. No.: US 2011/0058845 A1
(43) Pub. Date: Mar. 10, 2011

(54) BELT CLEANING APPARATUS AND IMAGE FORMING APPARATUS

(76) Inventor: Tomomi Tanaka, Osaka (JP)

(21) Appl. No.: 12/876,497

(22) Filed: Sep. 7, 2010

(30) Foreign Application Priority Data
Sep. 8, 2009 (JP) P2009-207526

(51) Int. Cl. G03G 15/16

(52) U.S. Cl. 399/101

(57) ABSTRACT

There is provided a belt cleaning apparatus which is excellent in removing efficiency of removing residual toner as well as is capable of efficiently removing foreign matters which are more difficult to be removed than the residual toner such as paper powder, talc and kaolin adhered to a cleaning section from the cleaning section, which makes it possible to form a high quality image over a long term. A belt cleaning apparatus is, when removing the residual toner by abutting on an outer circumferential surface of an intermediate transfer belt by a cleaning blade, configured to vibrate the intermediate transfer belt by applying alternating current voltage to an electrode member by a power source through a blade supporting member.

### CROSS-REFERENCE TO RELATED APPLICATION

This application claims priority to Japanese Patent Application No. 2009-207526, which was filed on Sep. 8, 2009, the contents of which are incorporated herein by reference in its entirety.

### BACKGROUND OF THE INVENTION

1. Field of the Invention

The present invention relates to a belt cleaning apparatus and an image forming apparatus.

2. Description of the Related Art

In an electrophotographic image forming apparatus is employed a method in which a toner image is obtained by developing an electrostatic latent image on an electrostatic latent image holding body with a toner and the toner image is transferred on a recording medium to form the toner image on the recording medium. As a transfer method in an image forming apparatus is used a transfer method in which a toner image formed on an electrostatic latent image holding body is transferred to a toner image bearing member which bears and conveys a toner image transferred thereto, the toner image transferred to the toner image bearing member is electrostatically moved to a recording medium by a transfer section which faces the intermediate transfer belt with the recording medium interposed therebetween. Then, a cleaning section is provided for removing residual toner remaining on the toner image bearing member after the toner image is transferred on the recording medium.

As a cleaning method in such an image forming apparatus, there has been used a cleaning method for removing residual toner from the toner image bearing member by mechanically scraping off the residual toner from the toner image bearing member while causing the cleaning section to be in contact with the toner image bearing member that bears and conveys the residual toner or by moving the residual toner from the toner image bearing member with electrostatic force generated by applying voltage to the cleaning section.

In such a cleaning method, it is preferable that adhesive force of the toner to the toner image bearing member is small in order to remove the residual toner from the toner image bearing member. Especially, when a toner whose degree of sphericity is high remains on the toner image bearing member as the residual toner, even though the cleaning section is caused to be in contact with the toner image bearing member for removing, it is difficult to remove the residual toner by scraping off effectively, therefore, it is important to reduce the adhesive force of the toner to the toner image bearing member.

Japanese Unexamined Patent Publication JP-A 2000-112267, Japanese Unexamined Patent Publication JP-A 2005-338141, and Japanese Unexamined Patent Publication JP-A 2007-47587 disclose image forming apparatuses capable of reducing the adhesive force of a toner to a toner image bearing belt which is the toner image bearing member. According to the image forming apparatus disclosed in JP-A 2000-112267, in a transfer section that transfers a toner image borne on a photoreceptor drum which is the electrostatic latent image holding body on recording paper which is the recording medium, a piezoelectric element is arranged to be in contact with an inner surface of a transfer belt so as to face a cleaning bias roller which is the cleaning section, and mechanical vibration by the piezoelectric element is imparted to the transfer belt, and thus the adhesive force of the toner to the transfer belt is able to be reduced.

Further, according to the image forming apparatus disclosed in JP-A 2005-338141, high frequency vibration of 20 Hz or more is applied to a supporting roller around which an intermediate transfer belt, which is the toner image bearing belt, is supported with tension for vibrating residual toner remaining on the intermediate transfer belt so that the adhesive force of the residual toner to the intermediate transfer belt is reduced, and thus cleaning performance of a cleaning fur blush arranged to face the supporting roller is able to be improved.

Further, according to the image forming apparatus disclosed in JP-A 2007-47587, in an intermediate transfer belt which is the toner image bearing belt that transfers a toner image borne on a photoreceptor drum on recording paper, an ultrasonic wave generating device is caused to be in pressure-contact with a small diameter part of a metal roller end part facing a cleaning blade which is the cleaning section on an inner surface of the intermediate transfer belt, and mechanical vibration is imparted to the intermediate transfer belt by the ultrasonic wave generating device so that the adhesive force of the toner to the intermediate transfer belt is able to be reduced.

However, in the image forming apparatus disclosed in JP-A 2000-112267, since an ultrasonic wave transducer such as the piezoelectric element is frictionally slid to the transfer belt, wear of a contact part between the piezoelectric element and the transfer belt occurs. Therefore, contact resistance between the inner surface of the transfer belt and a transfer electrode varies to cause a transfer electric field to be non-uniform, thus reducing transfer efficiency so that a uniform, high quality image is not able to be formed on the recording paper. Even though such a technology of reducing adhesive force of the toner by the piezoelectric element is applied to a position where residual toner is removed from the intermediate transfer belt which is the toner image bearing member, wear occurs non-uniformly in the contact part with the piezoelectric element on the intermediate transfer belt, and therefore, vibration to be imparted by the piezoelectric element to the intermediate transfer belt becomes non-uniform, thus the effect of reducing the adhesive force of the toner to the intermediate transfer belt by the piezoelectric element deteriorates. Accordingly, the apparatus is not the one which is excellent in removing efficiency of removing the residual toner from the intermediate transfer belt, and the toner remains on the intermediate transfer belt after transfer processing to the recording paper, therefore an effect of the residual toner is exerted during image formation on next recording paper, and thus a high quality image is not able to be formed.

Further, in an image forming apparatus disclosed in JP-A 2005-338141, even though cleaning performance of the residual toner remaining on the intermediate transfer belt is improved, foreign matters which are more difficult to be removed than the residual toner such as paper powder, talc and kaolin adhered to the cleaning section are not able to be removed from the cleaning section.

Further, in the image forming apparatus disclosed in JP-A 2007-47587, the ultrasonic wave generating device is vibrated while being in pressure-contact with the small diameter part of the metal roller end part, and thus wear occurs in the pressure-contact part of the ultrasonic wave generating device. Moreover, although the vibration generated by the ultrasonic wave generating device in pressure-contact with the small diameter part of the metal roller end part is transmitted on the surface of the intermediate transfer belt in contact with the metal roller in a width direction, it is not possible to vibrate the intermediate transfer belt in a direction corresponding to the radial direction of the metal roller. Therefore, as well as the transmission of the vibration generated at the pressure-contact part in the small diameter part of the metal roller end part is not stabilized, the intermediate transfer belt is not able to be vibrated in the direction corresponding to the radial direction of the metal roller, and thus the effect of reducing the adhesive force of the toner to the intermediate transfer belt is not able to be said to be sufficient. Accordingly, the apparatus is not the one which is excellent in removing efficiency of removing the residual toner from the intermediate transfer belt and the toner remains on the intermediate transfer belt after the transfer processing to the recording paper, and therefore, the effect of the residual toner is exerted during image formation on next recording paper so that a high quality image is not able to be formed.

### SUMMARY OF THE INVENTION

Therefore, an object of the invention is to provide a belt cleaning apparatus which removes residual toner remaining on an outer circumferential surface of a toner image bearing belt that bears and conveys a toner image, after the toner image is transferred to a recoding medium, and is excellent in removing efficiency of removing residual toner, is capable of efficiently removing foreign matters which are more difficult to be removed than the residual toner such as paper powder, talc and kaolin adhered to a cleaning section, and makes it possible to form a high quality image over a long term, and to provide an image forming apparatus provided with the belt cleaning apparatus.

The invention provides a belt cleaning apparatus which removes residual toner remaining on an outer circumferential surface of an endless toner image bearing belt that is rotatably supported around a plurality of supporting rollers with tension and bears and conveys a toner image, after the toner image is transferred to a recoding medium, comprising:

a cleaning blade which is formed by a plate-like elastic member and removes the residual toner by abutting on an outer circumferential surface of the toner image bearing belt;

a blade supporting member provided to be in contact with the cleaning blade to support the cleaning blade;

an electrode member facing the blade supporting member with a predetermined gap therebetween; and

a power source which applies an alternating current voltage having a predetermined frequency to the electrode member, wherein when the cleaning blade removes residual toner by abutting on the outer circumferential surface of the toner image bearing belt, the power source applies an alternating current voltage to the electrode member so as to vibrate the blade supporting member, thereby vibrating the toner image bearing belt.

According to the invention, the belt cleaning apparatus is an apparatus that removes residual toner on an outer circumferential surface of an endless toner image bearing belt which bears and conveys a toner image, after the toner image is transferred to a recording medium. The belt cleaning apparatus comprises a cleaning blade which abuts on the outer circumferential surface of the toner image bearing belt, a blade supporting member which supports the cleaning blade, an electrode member which faces the blade supporting member with a predetermined gap therebetween and a power source which applies an alternating current voltage to the electrode member. Then, in the belt cleaning apparatus, when the cleaning blade removes residual toner by abutting on the outer circumferential surface of the toner image bearing belt, the power source applies an alternating current voltage having a predetermined frequency to the electrode member. In this manner, when the alternating current voltage is applied to the electrode member, oscillating electric field is formed in the gap between the electrode member and the blade supporting member, and with the oscillating electric field, the blade supporting member and the cleaning blade supported by the blade supporting member are vibrated so that the toner image bearing belt on which the cleaning blade abuts vibrates. By the vibration of the toner image bearing belt, the adhesive force of residual toner remaining on the toner image bearing belt to the toner image bearing belt is reduced by inertial force due to mass of the toner itself. Thereby, the apparatus is excellent in removing efficiency of removing residual toner remaining on the toner image bearing belt after transfer processing to the recoding medium, prevents the effect of the residual toner from being exerted during image formation to a next recording medium and is capable of forming a high quality image.

Further, in the conventional art, since the ultrasonic wave transducer is caused to be in contact with the toner image bearing belt and vibrated, due to usage over a long term, wear occurs in the contact part between the ultrasonic wave transducer and the toner image bearing belt. On the other hand, in the belt cleaning apparatus of the invention, it is so configured that the toner image bearing belt is vibrated in being non-contact with the oscillating electric field that is generated in the gap between the electrode member and the blade supporting member, therefore, there will be no wear in each of the electrode member, the cleaning blade and the toner bearing belt over a long term due to vibration. Therefore, over a long term, removing efficiency of removing residual toner remaining on the toner image bearing belt after the transfer processing for the recording medium is maintained at a high state and the effect of the residual toner is prevented from being exerted during image formation to next recording medium and thus a high quality image is able to be formed.

Further, in the belt cleaning apparatus, when the cleaning blade removes the residual toner by abutting on the toner image bearing belt, the blade supporting member and the cleaning blade supported by the blade supporting member vibrate with the oscillating electric field generated in the gap between the electrode member and the blade supporting member, therefore, foreign matters which are more difficult to be removed than the residual toner such as paper powder, talc, and kaolin adhered to the cleaning blade are able to be removed from the cleaning blade effectively.

Further, in the invention, it is preferable that the electrode member is provided with a coat layer composed of an insulating material on a surface thereof facing the blade supporting member.

According to the invention, the electrode member is provided with the coat layer composed of an insulating material on a surface thereof facing the blade supporting member. In this way, by providing the coat layer composed of an insulating material on the surface of the electrode member, even when high voltage is applied to the electrode member, generation of aerial discharge is able to be prevented compared with the case where a part facing the blade supporting member is composed of a conductive body. Therefore, a great oscillating electric field is able to be generated in the gap between the blade supporting member and the electrode member by applying the high voltage to the electrode member.

Further, in the invention, it is preferable that a flexural rigidity of the electrode member in a facing direction to the blade supporting member is higher than a flexural rigidity of the blade supporting member in a facing direction to the electrode member.

According to the invention, it is configured that the flexural rigidity of the electrode member in the facing direction to the blade supporting member is higher than the flexural rigidity of the blade supporting member in the facing direction to the electrode member. Thereby, when attracting force by the oscillating electric field generated in the gap between the electrode member and the blade supporting member acts, the blade supporting member is able to be vibrated while suppressing deflection of the electrode member. Furthermore, when the electrode member is deflected, width of the gap between the electrode member and the blade supporting member becomes small with the deflection, and thus the aerial discharge is easily generated. By increasing the flexural rigidity of the electrode member to suppress the deflection of the electrode member, it is possible to prevent the width of the gap between the electrode member and the blade supporting member from becoming excessively small, even when the high voltage is applied to the electrode member, and thus the blade supporting member is greatly vibrated so as to impart the great vibration to the toner image bearing belt.

Further, in the invention, it is preferable that a frequency of the alternating current voltage that the power source applies to the electrode member is 20 kHz or more.

According to the invention, the frequency of the alternating current voltage that the power source applies to the electrode member is 20 kHz or more. When the blade supporting member vibrates with the oscillating electric field generated in the gap between the electrode member and the blade supporting member, aerial vibration generated by the vibration of the blade supporting member becomes above human audible frequency, and thus a sense of discomfort during operation is able to be prevented.

Further, the invention provides an image forming apparatus comprising:

a photoreceptor on which an electrostatic latent image is to be formed;

a developing section that develops the electrostatic latent image on a surface of the photoreceptor to form a toner image;

an endless toner image bearing belt that is rotatably supported around a plurality of supporting rollers with tension and bears and conveys the toner image;

a transfer section that transfers the toner image borne on an outer circumferential surface of the toner image bearing belt to a recording medium; and

the belt cleaning apparatus mentioned above that removes residual toner remaining on the outer circumferential surface of the toner image bearing belt after the toner image is transferred to the recording medium.

According to the invention, the image forming apparatus comprises the belt cleaning apparatus according to the invention. Thereby, the image forming apparatus is capable of forming a high quality image without image failure based on cleaning failure of the toner image bearing belt over a long term and stably.

### BRIEF DESCRIPTION OF THE DRAWINGS

Other and further objects, features, and advantages of the invention will be more explicit from the following detailed description taken with reference to the drawings wherein:

FIG. 1 is a view showing a configuration of an image forming apparatus according to an embodiment of the invention;

FIG. 2 is a view showing a configuration of a belt cleaning apparatus according to a first embodiment of the invention;

FIGS. 3A to 3C are views for explaining the vibration mode of the blade supporting member; and

FIG. 4 is a view showing a configuration of a belt cleaning apparatus according to a second embodiment of the invention.

### DETAILED DESCRIPTION

Now referring to the drawings, preferred embodiments of the invention are described below.

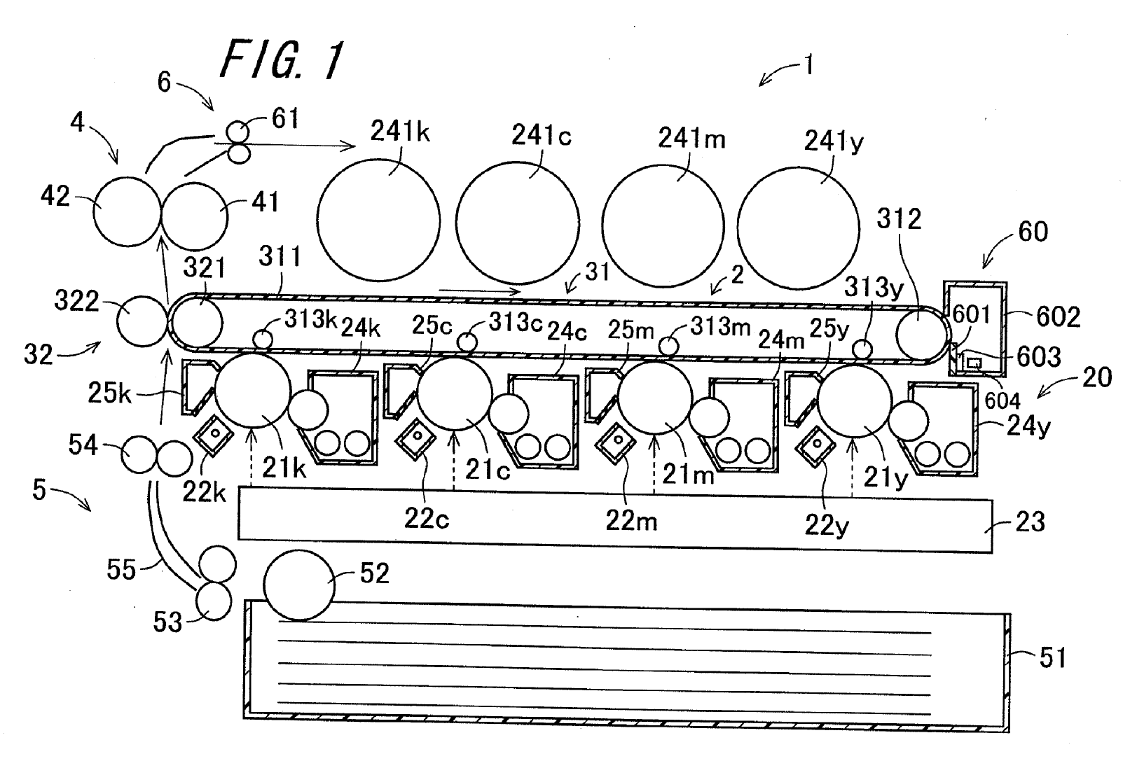

FIG. 1 is a view showing a configuration of an image forming apparatus 1 according to an embodiment of the invention. The image forming apparatus 1 is a tandem-type color image forming apparatus capable of forming a color image. The image forming apparatus 1 is one which has a printer function of forming a color image or a monochrome image for a recording paper sheet which is a recording medium based on image data transmitted from various terminal apparatuses such as a PC (Personal Computer) connected through a network or image data read by a document reading apparatus such as a scanner.

The image forming apparatus 1 includes an image forming station section 2, a secondary transfer station section 32, a fixing section 4, a paper supplying section 5 and a paper discharge section 6. The image forming station section 2 is separated into four image forming stations for a yellow image, a magenta image, a cyan image and a black image to correspond to image information of each of colors including yellow (y), magenta (m), cyan (c), and black (k) included in color image information. Then, in a rotation direction of an intermediate transfer belt 311 which is a toner image bearing belt which will be described below, the image forming stations for a yellow image, a magenta image, a cyan image, and a black image are arrayed in this order.

Each of the four image forming stations for a yellow image, a magenta image, a cyan image and a black image has substantially the same configuration and forms an image of yellow, magenta, cyan and black based on the image data corresponding to each color, so as to be overlaid on the intermediate transfer belt 311 to form an image composed of the four color toners, and a toner image is transferred onto a recording paper sheet in the secondary transfer station section 32. Then the toner image on the recording paper sheet is heated and pressurized in the fixing section 4, and thereby a full-color image is formed on the recording paper sheet.

Each member constituting the image forming station section 2 is provided by four pieces respectively for corresponding to the image information of each color of black (k), cyan (c), magenta (m) and yellow (y) included in the color image information. Here, each member provided by four pieces corresponding to each color is distinguished by adding an alphabet representing each color at the end of the reference number and in a case of calling the member as all inclusive term, denotation is made only by the reference number.

The image forming station section 2 has a toner image forming section 20 and a primary transfer section 31. The toner image forming section 20 includes a photoreceptor 21, a charging section 22, an exposure unit 23, a developing section 24 and a cleaner 25. The charging section 22, the developing section 24 and the cleaner 25 are arranged around the rotation direction of the photoreceptor 21 in this order.

The photoreceptor 21 is in the shape of a substantially cylindrical drum on the surface thereof an OPC (Organic Photoconductor) is provided, provided above the exposure unit 23 so as to be rotationally driven in a predetermined direction by a driving section and a control section. The charging section 22 is a charging device of a Scorotron method for uniformly charging the surface of the photoreceptor 21 to be predetermined potential, and is arranged to be close to the outer circumferential surface of the photoreceptor 21.

The exposure unit 23 has a function of exposing the surface of the photoreceptor 21 that is charged with the charging section 22 by irradiating laser light thereto based on image data outputted from an image processing section (not shown) to reduce the potential of the exposure section on the surface of the photoreceptor 21 so as to write and form an electrostatic latent image on the surface according to the image data. The exposure unit 23 forms an electrostatic latent image in accordance with a corresponding color when image data that corresponds to yellow, magenta, cyan, or black is inputted respectively according to the image forming stations corresponding to each color. As the exposure unit 23, a laser scanning unit (LSU) including a laser irradiation part and a reflection mirror or a writing device (for example, a write head) in which light emitting elements such as ELs (Electro Luminescences) and LEDs (Light Emitting Diodes) are arranged in an array is usable.

The developing section 24 has a developing roller serving as a developer bearing member that bears a developer, and a developing tank which contains the developer. Here, with using two-component developer including a toner and a carrier, a toner image is formed by performing reversal development with the toner of an electrostatic latent image that has been formed on the surface of the photoreceptor 21 by the exposure unit 23. Note that, the developer is not limited to the two-component developer and one-component developer is also usable. Further, the developing section 24 is provided with a toner bottle 241 that contains each toner corresponding to each color and supplies a toner to the developing tank according to a toner consumption amount. The developing roller is configured to convey a developer to a development area where the toner is able to be moved to the photoreceptor 21. Further, the toner in the developer contained in the developing tank is charged with a same polarity as that of a surface potential that is charged to the photoreceptor 21. Note that, both the polarity of the surface potential that is charged to the photoreceptor 21 and the charging polarity of the toner used are negative here.

The cleaner 25 is a unit for removing and collecting the toner remaining on the outer circumferential surface of the photoreceptor 21 after transferring the toner image to the intermediate transfer belt 311, and causes the cleaning blade composed of urethane rubber to abut on the surface of the photoreceptor 21.

The primary transfer section 31 includes the intermediate transfer belt 311 which is a toner image bearing belt, a counter roller 312, a primary transfer roller 313 and the belt cleaning apparatus 60 according to the invention. The intermediate transfer belt 311 is an endless belt member supported around a transfer roller 321 which is a member of constituting members of the secondary transfer station section 32 and the counter roller 312, with tension, to form a loop-shaped moving path, and is rotationally conveyed along with rotation of the transfer roller 321. The toner images formed on the photoreceptors 21 of the image forming stations of each of colors are registered and overlaid, thereby the toner image composed of four color toners is borne inside of the toner image bearing area of the surface thereof. The intermediate transfer belt 311 has a thickness of 80 μm, is composed of semi-conductive polyimide, and has volume resistivity of 10¹⁰ Ω·cm, surface resistivity of 10¹⁰ Ω/square.

The intermediate transfer belt 311 may be a two-layer structure in which an elastic layer composed of urethane rubber or the like is formed on a surface of a substrate composed of polyimide. In the intermediate transfer belt 311 having the elastic layer, the surface of the elastic layer serves as the toner image bearing area and the elastic layer elastically deforms corresponding to undulations of the recording paper sheet, and since the intermediate transfer belt 311 is in contact with the toner image so as to cover the toner image, it is possible to improve the transfer property.

The counter roller 312 is a supporting roller which faces the cleaning blade 601 included in a belt cleaning apparatus 60, which will be described below, with the intermediate transfer belt 311 interposed therebetween, and is formed to be a hollow cylinder shape. The counter roller 312 which is the cylinder having a thickness of 0.8 mm composed of aluminum (A5052) whose outer diameter is 30 mm and length of the axial direction is 310 mm, has a conductive resin flange at an end part thereof and is supported to be rotatable around the rotation shaft through a ball bearing. The counter roller 312 is driven to rotate along with rotation of the intermediate transfer belt 311. Then the counter roller 312 is electrically grounded through the rotation shaft.

When the intermediate transfer belt 311 passes through the photoreceptor 21 while being in contact with the photoreceptor 21, transfer bias whose polarity is opposite (positive polarity, here) to that of the charging polarity of the toner on the surface of the photoreceptor 21 is applied thereto from the primary transfer roller 313 which is arranged to face the photoreceptor 21 with the intermediate transfer belt 311 interposed therebetween, and a toner image formed on the surface of the photoreceptor 21 is transferred to and borne on the intermediate transfer belt 311. Then by the rotation of the intermediate transfer belt 311, the toner image composed of four color toners is conveyed to the secondary transfer station section 32.

The belt cleaning apparatus 60 is one for removing and collecting residual toner remaining on the outer circumferential surface of the intermediate transfer belt 311 after transferring the toner image on the recording paper sheet in the secondary transfer station section 32, and causes the cleaning blade 601 composed of urethane rubber similarly to the above-described cleaner 25 to abut on the intermediate transfer belt 311.

In the secondary transfer station section 32, the secondary transfer roller 322 is arranged to face the transfer roller 321 by which the intermediate transfer belt 311 is suspended, with the intermediate transfer belt 311 interposed therebetween. The intermediate transfer belt 311 is rotationally conveyed with the rotation of the transfer roller 321. To increase the frictional force with the intermediate transfer belt 311, the transfer roller 321 is provided with a rubber layer on the surface of the cylindrical part thereof, and connected to a driving motor (not shown) provided on the apparatus main body so as to be rotationally driven. Then, the secondary transfer roller 322 is in pressure-contact with the intermediate transfer belt 311 with a recording paper sheet interposed therebetween, which recording paper sheet is supplied and conveyed by the paper supplying section 5 in accordance with the timing of the conveyance of the toner image borne on the intermediate transfer belt 311. A part where the secondary transfer roller 322 is in pressure-contact with the intermediate transfer belt 311 is a transfer nip region. When the toner image borne on the intermediate transfer belt 311 and the recording paper sheet are passing through the transfer nip region in synchronization with each other, positive potential (transfer electric field) that attracts a toner is applied to the secondary transfer roller 322 and the toner image on the intermediate transfer belt 311 is transferred to the recording paper sheet.

The fixing section 4 is provided on a downstream side in the conveyance direction of the recording paper sheet of the secondary transfer station section 32, and includes a heating roller 41 and a pressure roller 42. The heating roller 41 is provided so as to be capable of driving rotationally by a driving section (not shown), and heats to fuse a toner constituting an unfixed toner image transferred and borne on the recording paper sheet. Inside the heating roller 41, a heating section (not shown) is provided. The heating section heats the heating roller 41 so that the surface of the heating roller 41 becomes a predetermined temperature (fixing temperature). As the heating section, a heater, a halogen lamp or the like is usable.

The pressure roller 42 is provided so as to be in pressure-contact with the heating roller 41 and supported to be rotatable according to the rotation drive of the heating roller 41. The pressure roller 42 fixes a toner image to a recording paper sheet in cooperation with the heating roller 41. At this time, the pressure roller 42 presses the toner in a fused state due to heat from the heating roller 41 against the recording paper sheet, thereby assisting fixation of the toner image to the recording paper sheet. A part where the heating roller 41 is in pressure-contact with the pressure roller 42 is a fixing nip region. With the fixing section 4, when the recording paper sheet to which a toner image is transferred in the secondary transfer station section 32 passes through the fixing nip region while being nipped by the heating roller 41 and the pressure roller 42, the toner image pressed against the recording paper sheet under heating allows the toner image to be fixed on the recording paper sheet so that an image is formed.

The paper supplying section 5 includes a paper supplying tray 51, a pick up roller 52, registration rollers 53, conveying rollers 54 and a paper guide 55. The paper supplying tray 51 is provided on a lower part in a direction perpendicular to the image forming apparatus 1 and is a container-like member which retains recording paper sheets. As the recording paper sheet, plain paper, color copy paper, a sheet for an overhead projector, a post card and the like are included. Moreover, in recent years, in relation to the environmental or energy saving measure, recycled paper is often used as the recording paper sheet. The recycled paper has a short paper fiber and contains more filler such as talc or kaolin because of the reason why a resistance value of the paper that is an index to enhance the whiteness is brought to be closer to that of non-recycled paper. In the case of using such recycled paper, improvement in the removing efficiency of the foreign matters adhered to the cleaning blade, which is an excellent effect in the invention which will be described below, is remarkably recognized.

The pick-up roller 52 takes out the recording paper sheet retained in the paper supplying tray 51 sheet by sheet so as to be sent and fed toward the registration rollers 53. The registration rollers 53 are a pair of roller members provided to be in pressure-contact with each other and send and feed the recording paper sheet sent and fed from the pick-up roller 52 to the paper guide 55 defining a conveyance path of the recording paper sheet so as to be sent and fed to the transfer nip region in synchronization with that the toner image borne on the intermediate transfer belt 311 is conveyed to the transfer nip region. The recording paper sheet sent and fed to the paper guide 55 is conveyed to the conveying rollers 54 which are a pair of roller members provided to be in pressure-contact with each other and conveyed to the transfer nip section.

The paper discharge section 6 includes a discharge roller 61. The discharge roller 61 is provided on a downstream side of the fixing nip region in the fixing section 4 in the paper conveyance direction, and discharges the recording paper sheet on which an image has been fixed by the fixing section 4 to a catch tray provided on the upper surface in the direction perpendicular to the image forming apparatus 1. The catch tray retains the recording paper sheet on which an image has been fixed.

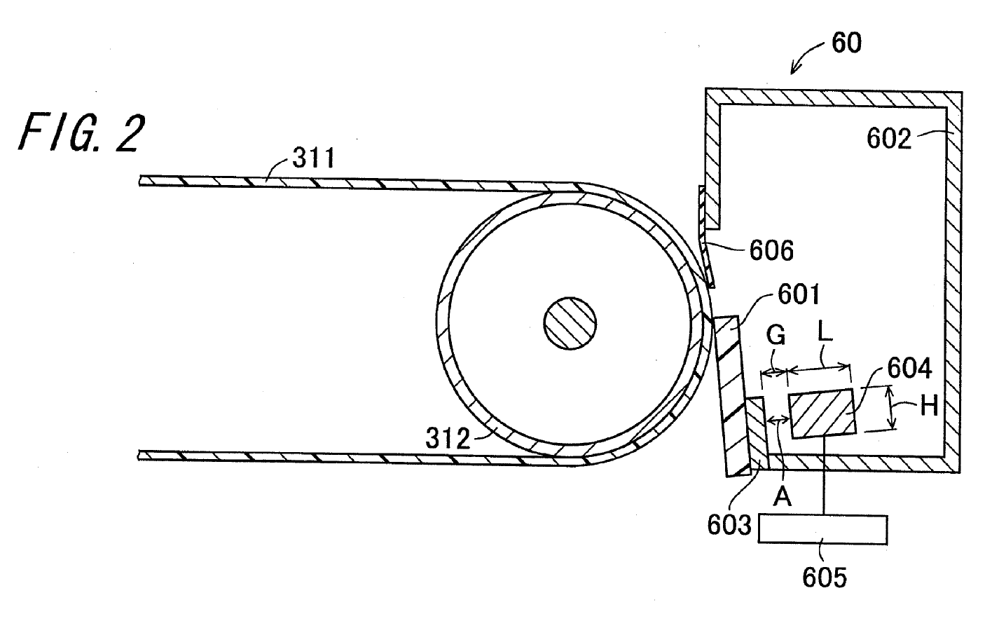

FIG. 2 is a view showing a configuration of the belt cleaning apparatus 60 according to a first embodiment of the invention. The belt cleaning apparatus 60 is an apparatus for removing the residual toner remaining on the outer circumferential surface of the intermediate transfer belt 311 after the toner image borne on the outer circumferential surface of the intermediate transfer belt 311 is transferred on the recording paper sheet. The belt cleaning apparatus 60 includes a cleaning blade 601, a waste toner case 602, a blade supporting member 603, an electrode member 604, a power source 605 and a scoop seal 606.

The cleaning blade 601 is a plate-like member composed of an elastic material, and provided to abut on the outer circumferential surface of the intermediate transfer belt 311. As the elastic material, one having appropriate elasticity is selected as appropriate among a synthetic resin, rubber and the like. Then, as to the cleaning blade 601, a side edge part facing the outer circumferential surface of the intermediate transfer belt 311, that is, an abutting side that abuts on the intermediate transfer belt 311 is formed to be linear in parallel with a width direction (a direction perpendicular to the rotation direction) of the intermediate transfer belt 311. In the embodiment, the cleaning blade 601 is a rectangular plate-like elastic member composed of urethane rubber, and a thickness thereof is about 2 mm.

A longitudinal direction of the cleaning blade 601 which is a rectangular plate-like elastic member corresponds to the width direction of the intermediate transfer belt 311, and a direction perpendicular to the longitudinal direction is a short-side direction of the cleaning blade 601. In such a cleaning blade 601, a side edge part on one end side of the short-side direction is an abutting side that abuts on the outer circumferential surface of the intermediate transfer belt 311. The side edge part on one end side of the short-side direction of the cleaning blade 601 is provided to abut on the outer circumferential surface in an area where the intermediate transfer belt 311 is in contact with the counter roller 312. Further, the cleaning blade 601 is provided so that a direction heading toward one end side of the short-side direction from the other end side of the short-side direction is to be a direction opposing to the rotation direction of the intermediate transfer belt 311.

The cleaning blade 601 configured in this manner abuts on the outer circumferential surface of the area where the side edge part on the one end side of the shot-side direction contacts the counter roller 312 of the intermediate transfer belt 311 in the state of being elastically deflected and scrapes off the residual toner remaining on the outer circumferential surface of the intermediate transfer belt 311 mechanically after the transfer processing so as to clean the outer circumferential surface of the intermediate transfer belt 311.

The blade supporting member 603 is a rectangular plate-like member which is provided to be in contact with the surface on the opposite side to the opposing surface to the intermediate transfer belt 311 on the other end side of the short-side direction of the cleaning blade 601, and supports the cleaning blade 601 by being connected to an opening end part of the waste toner case 602. The blade supporting member 603 is formed, for example, by aluminum, stainless steel (SUS), etc.

The waste toner case 602 is a container-like member for containing the residual toner scraped off from the intermediate transfer belt 311 by the cleaning blade 601 as a waste toner. The waste toner contained in the waste toner case 602 is conveyed to a waste toner waste bottle (not shown) by a waste toner conveying screw (not shown).

Above the cleaning blade 601, as to the scoop seal 606, one of edges thereof abuts lightly on the outer circumferential surface in the area of the intermediate transfer belt 311 contacting the counter roller 312 and causes the residual toner on the outer circumferential surface of the intermediate transfer belt 311 to pass to the abutting part of the cleaning blade 601 without scraping it off. Then the scoop seal 606 prevents the waste toner which has been scraped off by the cleaning blade 601 and contained in the waste toner case 602 from leaking out from the waste toner case 602. In the embodiment, the scoop seal 606 is composed of a urethane rubber sheet whose thickness is 0.1 mm. Another edge of the scoop seal 606 is connected to the opening end part of the waste toner case 602.

The electrode member 604 is arranged to face the blade supporting member 603 with a predetermined gap therebetween. A material constituting the electrode member 604 may be a conductive material such as stainless steel (SUS), aluminum (Al), copper (Cu), brass or carbon, but not particularly limited thereto and in the embodiment, the material is composed of stainless steel. Further in the embodiment, the electrode member 604 is formed into a cube shape and a dimension L which corresponds to an opposing direction A to the blade supporting member 603 is 20 mm and a dimension H which corresponds to a direction orthogonal to the opposing direction A is 10 mm. Here, the opposing direction A is a direction that heads toward the blade supporting member 603 from the electrode member 604, and a direction opposing thereto. Then, a length of the electrode member 604 extending in the axial direction of the counter roller 312 is 300 mm corresponding to a dimension in the longitudinal direction of the cleaning blade 601 and the blade supporting member 603. Then, in the embodiment, the gap width G of the gap between the electrode member 604 and the blade supporting member 603 is set to be 200 μm.

The power source 605 applies alternating current voltage having a predetermined frequency and an amplitude to the electrode member 604. In the embodiment, the power source 605 applies the alternating current voltage whose frequency is 2.2 kHz and having sinusoidal waveform whose amplitude is 4 kVpp to the electrode member 604, and offset voltage is 0 V. After the toner image borne on the intermediate transfer belt 311 is transferred on the recording paper sheet in the secondary transfer station section 32, the power source 605 starts to supply the voltage to the electrode member 604 in accordance with the timing at which a tip end of an image of the residual toner remaining on the intermediate transfer belt 311 reaches a predetermined position on an upstream side of the belt cleaning apparatus 60 (for example, a position on an upstream side of the belt cleaning apparatus 60 by 100 mm), and stops to supply the voltage to the electrode member 604 when a rear end of the image of the residual toner is at a predetermined position on a downstream side of the belt cleaning apparatus 60 (for example, a position on a downstream side of the belt cleaning apparatus 60 by 100 mm).

According to the belt cleaning apparatus 60, when the alternating current voltage having the predetermined frequency and the amplitude is applied to the electrode member 604 arranged to face the blade supporting member 603, an oscillating electric field is formed in the gap G between the electrode member 604 and the blade supporting member 603. With the oscillating electric field, the blade supporting member 603 and the cleaning blade 601 supported by the blade supporting member 603 are vibrated in the opposing direction A and the intermediate transfer belt 311 is vibrated in the opposing direction A in an area where the intermediate transfer belt 311 is suspended by the opposing roller 312. When the intermediate transfer belt 311 vibrates in the opposing direction A, the residual toner remaining on the outer circumferential surface of the intermediate transfer belt 311 vibrates in the opposing direction A, and by the inertial force generated by the vibration, the adhesive force of the residual toner to the intermediate transfer belt 311 is reduced. Thereby the belt cleaning apparatus is excellent in removing efficiency of removing the residual toner remaining on the intermediate transfer belt 311 by the cleaning blade 601 after transfer processing to the recording paper sheet, prevents the effect of the residual toner from being exerted during image formation on next recording paper sheet, and is able to form a high quality image.

Further, in the conventional art, since an ultrasonic wave transducer is brought into contact with the intermediate transfer belt 311 to be vibrated, along with usage over a long term, wear occurs in a contact part between the ultrasonic wave transducer and the intermediate transfer belt 311. On the other hand, in the belt cleaning apparatus 60 of the invention, since it is so configured that the intermediate transfer belt 311 is vibrated in non-contact with the oscillating electric field that is generated in the gap G between the electrode member 604 and the blade supporting member 603, therefore, there will be no occurrence of wear due to vibration in each of the electrode member 604, the cleaning blade 601 and the intermediate transfer belt 311 over a long term. Therefore, over a long term, removing efficiency of removing the residual toner remaining on the intermediate transfer belt 311 by the cleaning blade 601 after the transfer processing to the recording paper sheet is maintained at a high state and the effect of the residual toner is prevented from being exerted during image formation on next recording paper sheet and thus a high quality image is able to be formed.

Further, when a toner whose degree of sphericity is high remains on the intermediate transfer belt 311 as the residual toner, it is difficult to remove the residual toner from the intermediate transfer belt 311 with action of mechanical scraping off of the cleaning blade 601. However, in the belt cleaning apparatus 60 of the invention, since the intermediate transfer belt 311 vibrates in the opposing direction A, the adhesive force of the residual toner to the intermediate transfer belt 311 is reduced so that the removing efficiency of removing by the cleaning blade 601 is maintained at a high state.

Further, in the belt cleaning apparatus 60, when the cleaning blade 601 abuts on the intermediate transfer belt 311 to remove the residual toner, the blade supporting member 603 and the cleaning blade 601 supported by the blade supporting member 603 vibrate with the oscillating electric field generated in the gap G between the electrode member 604 and the blade supporting member 603. Therefore, foreign matters which are more difficult to be removed than the residual toner such as paper powder, talc, and kaolin adhered to the cleaning blade 601 are able to be removed from the cleaning blade 601 effectively.

Next, description will be given for a matter needed to be considered in order to improve the removing efficiency of removing the residual toner by the cleaning blade 601 by vibrating the residual toner remaining on the intermediate transfer belt 311 in the opposing direction A so that the adhesive force thereof to the intermediate transfer belt 311 is reduced.

When assuming a capacitor in which the electrode member 604 and the blade supporting member 603 serve as the electrode plates, attracting force F that acts between the electrode plates is represented by an expression (1) shown below.

F=(1/2)×Q×E (1)

wherein F denotes the attracting force which acts between the electrode plates, Q denotes an electric charge amount, and E denotes strength of the electric field.

Further, the electric charge amount Q is represented by an expression (2) shown below.

Q=(∈S/d)V (2)

wherein ∈ denotes a relative dielectric constant, S denotes an opposing area, d denotes a gap between the electrodes, and V denotes a potential difference.]

In a case where, for example, S=300 mm×5 mm, d=200 μm, ∈=8.85×10⁻¹² (s⁴·A²·kg⁻¹·m⁻³), and V=2 kV are substituted into the expressions (1) and (2) and the attracting force F that acts between the electrode plates is calculated, then there is obtained F=0.66 N.

That is to say, when the alternating current voltage is applied to the electrode member 604 from the power source 605, the attracting force as described above acts between the electrode member 604 and blade supporting member 603, and the attracting force is generated repeatedly at the frequency of the applying voltage. Thereby the blade supporting member 603 and the cleaning blade 601 supported by the blade supporting member 603 vibrate in the opposing direction A at the vibration amplitude corresponding to the attraction force and at the vibration frequency corresponding to the frequency of the applying voltage. Then, along with the vibration of the blade supporting member 603 and the cleaning blade 601, the intermediate transfer belt 311 vibrates in the opposing direction A in the area being suspended by the opposing roller 312 at the above-described vibration amplitude and the vibration frequency.

According to the description above, the vibration frequency of the intermediate transfer belt 311 is able to be adjusted with the frequency of the applying voltage applied to the electrode member 604, however, in order to improve the removing efficiency of the residual toner by reducing the adhesive force of the residual toner to the intermediate transfer belt 311, the frequency of the applying voltage is required to be adjusted to a predetermined value or more. That is, as described above, by the inertial force generated by the vibration of the residual toner, the adhesive force of the residual toner to the intermediate transfer belt 311 is reduced, however, when the frequency of the applying voltage is too low, the inertial force imparted to the residual toner becomes excessively small to cause the reducing breadth of the adhesive force to be small so that improvement of the removing efficiency of the residual toner is not able to be recognized. Therefore, in the embodiment, the frequency of the applying voltage to be applied to the electrode member 604 is set to be 2.2 kHz.

Further, it is preferable that the frequency of the applying voltage to be applied to the electrode member 604 is 20 kHz or more (for example, 22 kHz). Thereby aerial vibration generated by the vibration of the blade supporting member 603 becomes above human audible frequency, and thus a sense of discomfort during operation is able to be prevented.

Further, as clearly shown from the expressions (1) and (2), the vibration amplitude of the intermediate transfer belt 311 which corresponds to the attracting force generated between the electrode member 604 and the blade supporting member 603 is able to be made greater by making the dielectric constant of the material constituting the electrode member 604 and the blade supporting member 603 higher, the opposing area between the electrode member 604 and the blade supporting member 603 larger, the applying voltage to be applied to the electrode member 604 higher, and the gap width between the electrode member 604 and the blade supporting member 603 smaller. In this manner, when the vibration amplitude of the intermediate transfer belt 311 becomes greater, the inertial force to be applied to the residual toner remaining on the intermediate transfer belt 311 becomes greater, and the adhesive force of the residual toner to the intermediate transfer belt 311 is reduced. However, when the applying voltage to be applied to the electrode member 604 is excessively high, or the case where the gap width between the electrode member 604 and the blade supporting member 603 is excessively small, which is not preferable because aerial discharge will be generated.

Further, by making the applying voltage to be applied to the electrode member 604 by the power source 605 serve as characteristic vibration voltage which is the alternating current voltage having the frequency which is an integral multiple of characteristic vibration frequency of the blade supporting member 603, the cleaning blade 601 resonates to be able to obtain the great vibration amplitude so that the adhesive force of the residual toner to the intermediate transfer belt 311 is reduced to be able to improve the removing efficiency of removing by the cleaning blade 601.

Further, when a beam extending in a longitudinal direction of the blade supporting member 603 and the electrode member 604 is considered, a flexural rigidity thereof is represented by Z=E×I (E denotes Young's modulus, I denotes second moment of area).

In the electrode member 604 whose dimension L corresponding to the opposing direction A to the blade supporting member 603 is 20 mm, and whose dimension H corresponding to the direction orthogonal to the opposing direction A is 10 mm, the second moment of area I is represented by an expression (3) shown below.

I=(H×L³)/12 (3)

When the material constituting the electrode member 604 is stainless steel, Young's modulus E of the stainless steel=170 GPa, and the flexural rigidity Z of the electrode member 604 is Z=E×I=1.1×10³ N·m².

By setting the flexural rigidity Z of the electrode member 604 in the opposing direction A to the blade supporting member 603 to be higher than the flexural rigidity of the blade supporting member 603 in the opposing direction A to the electrode member 604, when attracting force with the oscillating electric field generated in the gap G between the electrode member 604 and the blade supporting member 603 acts, the blade supporting member 603 is able to be vibrated while suppressing the deflection of the electrode member 604.

Further, when the electrode member 604 is deflected, the gap width between the electrode member 604 and the blade supporting member 603 becomes small due to this deflection and the aerial discharge is easily generated. By making the flexural rigidity of the electrode member 604 higher to suppress the deflection of the electrode member 604, it is possible to prevent that the gap width between the electrode member 604 and the blade supporting member 603 becomes excessively small even when high voltage is applied to the electrode member 604, so that the blade supporting member 603 and the cleaning blade 601 are vibrated greatly and the vibration whose vibration amplitude is great is able to be imparted to the intermediate transfer belt 311.

Further, it is preferable to be configured such that when the power source 605 applies the above-described characteristic vibration voltage to the electrode member 604, the cleaning blade 601 abuts on a part of the intermediate transfer belt 311 corresponding to an antinode section of the vibration in the vibration mode generated in the blade supporting member 603 so that the residual toner is scraped off to be removed. The part of the intermediate transfer belt 311 corresponding to an antinode section of the vibration in the vibration mode generated in the blade supporting member 603 is to be imparted with the vibration whose vibration amplitude is great. Therefore, the residual toner on the intermediate transfer belt 311 is able to be vibrated with the great vibration amplitude, and the inertial force acting on the residual toner becomes great so that the adhesive force of residual toner to the intermediate transfer belt 311 is able to be reduced.

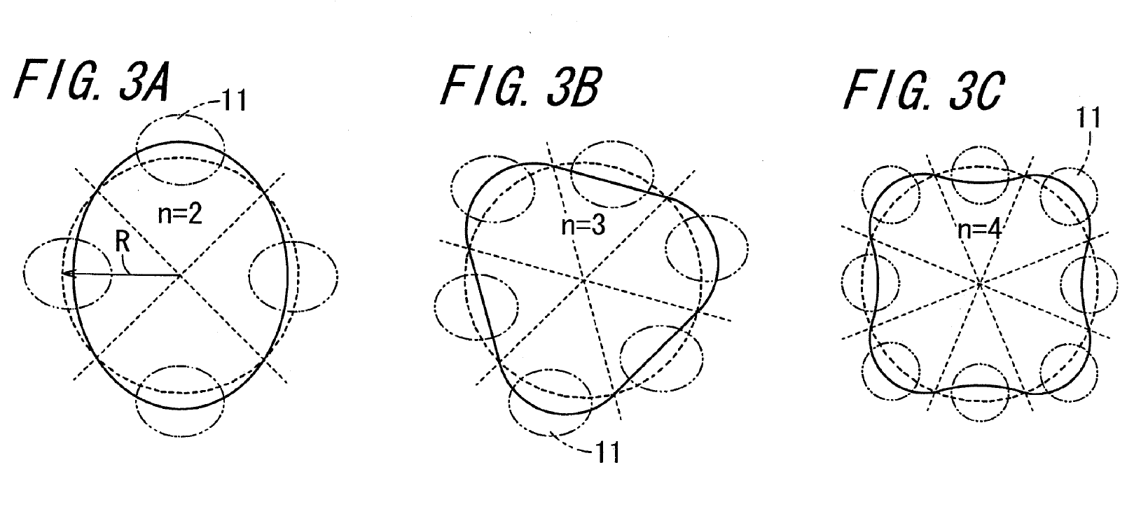

Specifically, description will be given below with using FIGS. 3A to 3C. FIGS. 3A to 3C are views for explaining the vibration mode of the blade supporting member 603. When the alternating current voltage with a basic characteristic vibration frequency which is one time of the characteristic vibration frequency of the blade supporting member 603 is applied to the electrode member 604, the vibration mode of the blade supporting member 603 is, as shown in FIG. 3A, a primary vibration mode (n=2). At this time, the amplitude in an antinode section 11 which is a part corresponding to the antinode of the vibration is the maximum. Further, also in a secondary vibration mode (n=3) as shown in FIG. 3B and a tertiary vibration mode (n=4) as shown in FIG. 3C, amplitude in the antinode section 11 of the vibration is the maximum. The cleaning blade 601 may abut on a part of the intermediate transfer belt 311 corresponding to the antinode section 11 of the vibration of the blade supporting member 603.

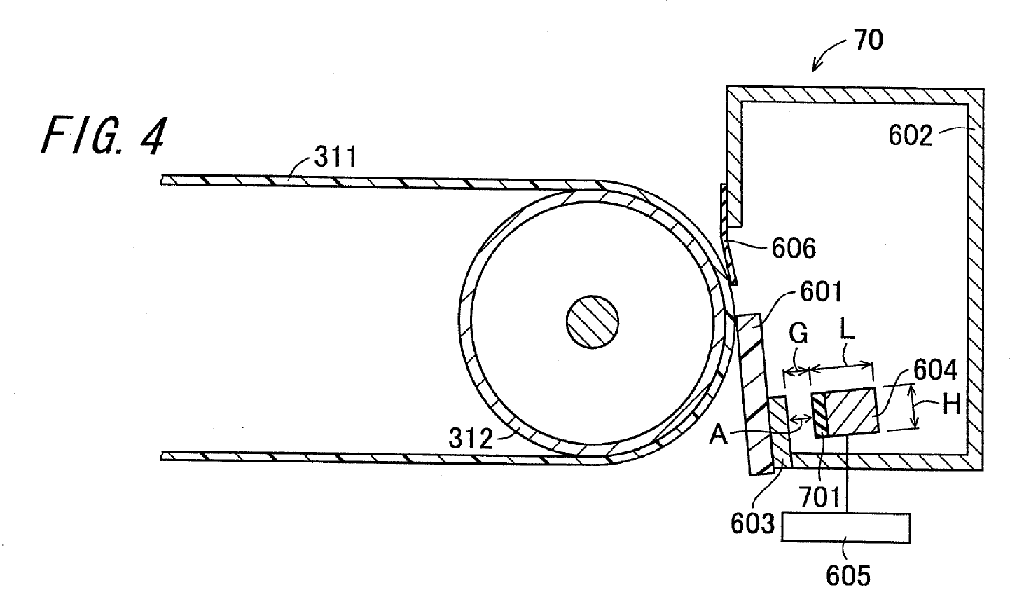

FIG. 4 is a view showing a configuration of the belt cleaning apparatus 70 according to a second embodiment of the invention. The belt cleaning apparatus 70 is similar to the belt cleaning apparatus 60, and therefore, the same reference numbers are given to the parts corresponding thereto and the description thereof is omitted. The characteristic configuration of the belt cleaning apparatus 70 is a point that a coat layer 701 composed of an insulating material is provided in a part of the electrode member 604 facing the blade supporting member 603. The belt cleaning apparatus 70 is configured similarly to the belt cleaning apparatus 60 except that the coat layer 701 is provided on the electrode member 604.

As a material constituting the coat layer 701, for example, an insulating material whose dielectric constant is high such as barium titanate (relative dielectric constant; 1200), strontium titanate (relative dielectric constant; 332) or titanium oxide (relative dielectric constant; 100) is preferable. By providing the coat layer 701 composed of the insulating material on the surface of the electrode member 604 in this manner, even when high voltage is applied to the electrode member 604, generation of the aerial discharge is able to be prevented compared with the case where the part facing the blade supporting member 603 is composed of a conductive body. Thus the alternating current voltage to be applied to the electrode member 604 of the belt cleaning apparatus 70 is set to be higher than the Paschen's discharge voltage in the air which is higher voltage than the alternating current voltage to be applied to the electrode member 604 of the belt cleaning apparatus 60. In this manner, a great oscillating electric field is able to be generated in the gap between the blade supporting member 603 and the electrode member 604.

Further, since the coat layer 701 composed of the insulating material has a high dielectric constant, further greater oscillating electric field is able to be generated in the gap between the blade supporting member 603 and the electrode member 604. Therefore, the blade supporting member 603 and the cleaning blade 601 are to be greatly vibrated so that the great vibration is able to be imparted to the intermediate transfer belt 311. Therefore, it is possible to reduce the adhesive force of the residual toner to the intermediate transfer belt 311, to achieve excellent removing efficiency of removing the residual toner remaining on the intermediate transfer belt 311 after transfer processing to the recording paper sheet, to prevent the effect of the residual toner to be exerted in the image formation on the next recording paper sheet, and to form a high quality image.

The embodiment described above is merely an illustration of the invention and the configuration thereof is able to be changed within the scope of the invention. For example, the description has been given for the configuration of vibrating the intermediate transfer belt when removing the residual toner remaining on the intermediate transfer belt. However, the invention is not limited thereto and for example, a configuration of removing the residual toner by vibrating a photoreceptor belt and an intermediate transfer belt in an image forming apparatus configured to form an image by transferring a toner image from the photoreceptor belt to the intermediate transfer belt and the toner image transferred on the intermediate transfer belt is transferred on a recording paper sheet, and a configuration of removing the residual toner by vibrating a photoreceptor belt in an image forming apparatus configured to form an image by transferring a toner image borne on the photoreceptor belt to a recording paper sheet directly, are also within the scope of the invention.

Further, although description has been given for the configuration in which the cleaning blade is caused to abut on the outer circumferential surface of the intermediate transfer belt to scrape off and remove the residual toner remaining on the intermediate transfer belt, the invention is also applicable to a configuration in which, in place of the cleaning blade, another cleaning section such as a bias cleaning roller or a fur brush cleaning section to which an electric field to attract the residual toner is applied is used.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A belt cleaning apparatus which removes residual toner remaining on an outer circumferential surface of an endless toner image bearing belt that is rotatably supported around a plurality of supporting rollers with tension and bears and conveys a toner image, after the toner image is transferred to a recoding medium, comprising:
a cleaning blade which is formed by a plate-like elastic member and removes the residual toner by abutting on an outer circumferential surface of the toner image bearing belt;
a blade supporting member provided to be in contact with the cleaning blade to support the cleaning blade;
an electrode member facing the blade supporting member with a predetermined gap therebetween; and
a power source which applies an alternating current voltage having a predetermined frequency to the electrode member, wherein when the cleaning blade removes residual toner by abutting on the outer circumferential surface of the toner image bearing belt, the power source applies an alternating current voltage to the electrode member so as to vibrate the blade supporting member, thereby vibrating the toner image bearing belt.

2. The belt cleaning apparatus of claim 1, wherein the electrode member is provided with a coat layer composed of an insulating material on a surface thereof facing the blade supporting member.

3. The belt cleaning apparatus of claim 1, wherein a flexural rigidity of the electrode member in a facing direction to the blade supporting member is higher than a flexural rigidity of the blade supporting member in a facing direction to the electrode member.

4. The belt cleaning apparatus of claim 1, wherein a frequency of the alternating current voltage that the power source applies to the electrode member is 20 kHz or more.

5. An image forming apparatus comprising:
a photoreceptor on which an electrostatic latent image is to be formed;
a developing section that develops the electrostatic latent image on a surface of the photoreceptor to form a toner image;
an endless toner image bearing belt that is rotatably supported around a plurality of supporting rollers with tension and bears and conveys the toner image;
a transfer section that transfers the toner image borne on an outer circumferential surface of the toner image bearing belt to a recording medium; and
the belt cleaning apparatus of claim 1 that removes residual toner remaining on the outer circumferential surface of the toner image bearing belt after the toner image is transferred to the recording medium.
